(19) United States
(12) Patent Application Publication
(10) Pub. No.: US 2020/0019898 A1
(43) Pub. Date: Jan. 16, 2020

(54) EVALUATION OF NODES WRITING TO A DATABASE

(71) Applicant: salesforce.com, inc., San Francisco, CA (US)

(72) Inventor: Daniel Thomas Harrison, Newmarket (CA)

(21) Appl. No.: 16/035,460

(22) Filed: Jul. 13, 2018

(51) Int. Cl. G06Q 10/06; G06F 15/18; G06N 7/00; H04L 9/06; G06F 17/30

(52) U.S. Cl. CPC G06Q 10/0633; G06F 15/18; G06F 17/30194; G06Q 10/06315; H04L 9/0637; G06N 7/00

(57) ABSTRACT

Techniques are disclosed relating to evaluating nodes of a process. A computer system may receive instance data that relates to an instance of a multi-step process and is written by a set of the plurality of nodes that performed the instance according to a particular ordering. The computer system may process the instance data to produce path data that corresponds to a path indicative of the particular ordering. The computer system may further receive feedback data indicative of an outcome of the instance. The computer system may process the path data and the feedback data to update a model that indicates confidence scores for the plurality of nodes. The computer system may determine, using confidence scores indicated by the model, that one or more of the set of nodes do not satisfy a quality threshold.

### BACKGROUND

### Technical Field

This disclosure relates generally to the evaluation of information submitted to a database of a computer system.

### Description of the Related Art

A multi-step process is a series of two or more steps that are taken in order to achieve a particular end. In many cases, multiple actors are involved in completing a process, with the result of one actor passed to a next actor. These actors may be computers, such as in the case of network routers that work together to route data packets to a recipient. Other actors may be individuals or entities, such as those in a shipping process for a physical good that involves a sender, one or more distributors, and a recipient.

In many instances, different orderings or combinations of actors may be used to perform a given multi-step process. To ensure process integrity, computer systems, particularly database computer systems, may be used to track different instances of multi-step process by communicating with computing devices associated with each actor in the process. Tracking may be useful, for example, to determine a cause of failure of a particular instance of a process. There may be various causes for failure by various actors in the system. In a shipping scenario, for instance, a particular actor may be maliciously manipulating the process, or simply unreliable. In other cases, a particular actor may be deemed to be a point of failure for circumstances beyond the actor's control (e.g., bad weather conditions). In any event, accurately tracking different instances of a multi-step process, such as to assess a point of failure, is often difficult. This is particularly true when there are many instances and many actors involved.

### BRIEF DESCRIPTION OF THE DRAWINGS

FIG. 1 is a block diagram illustrating example elements of a system for evaluating nodes in a multi-step process, according to some embodiments.

FIG. 2 is a block diagram illustrating example elements of a database capable of storing data received from nodes, according to some embodiments.

FIG. 3 is a block diagram illustrating example elements of a computer system that builds and maintains a model, according to some embodiments.

FIG. 4A-B are block diagrams illustrating example elements of a management flow and an application flow, according to some embodiments.

FIG. 5 is a block diagram illustrating example elements of multiple paths that relate to a multi-step process, according to some embodiments.

FIG. 6 is a block diagram illustrating example elements of a structure layout indicating paths for an instance of a multi-step process, according to some embodiments.

FIGS. 7-9 are flow diagrams illustrating example methods relating to evaluating nodes writing data to a database, according to some embodiments.

FIG. 10 is a block diagram illustrating an example computer system, according to some embodiments.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “network interface configured to communicate over a network” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, in a single-use password that has multiple portions, the terms “first” portion and “second” portion can be used to refer to any portion of the single-use password. In other words, the first and second portions are not limited to the initial two portions of a single-use password.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

### DETAILED DESCRIPTION

The present disclosure describes various techniques for evaluating data written to a database, where the data is written by multiple actors and relates to the performance of a multi-step process involving those actors. The term “node” will be used for the remainder of this disclosure to refer to an actor in a multi-step process—the term may be used to refer both to the actor and a computing device associated with the actor. The term “path,” on the other hand, is used to refer to an ordering of a particular set of nodes. For example, one path might include the nodes A, B, C, and D, ordered as follows: A→B→C→D, while a different path with the same nodes might be A→C→B→D. A different path might be A→E→F→G. Still further, an “instance” of a multi-step process refers to an individual performance of the multi-step process according to some path. Thus, different acts of shipping goods via the path A→E→F→G would correspond to different instances of the multi-step process.

Various embodiments of a computer system are described below that utilize data written by nodes to ultimately determine which nodes are contributing to failures of instances of multi-step processes. In some embodiments, a computer system may evaluate instances of a multi-step process by utilizing data written by nodes participating in that process. In various embodiments, instance data is written by nodes in a multi-step process to one or more records in a database implemented as a distributed ledger. A computer system may evaluate the data by processing the instance data (e.g., by formatting it appropriately to provide to an artificial intelligence system) that it receives from the one or more records to produce path data that corresponds to a path through the nodes involved in the instance of the multi-step process. The computer system may also receive feedback data indicating an outcome (e.g., success or failure) of the instance of the multi-step process. (In some cases, feedback data can be considered to be a particular form of instance data if written by one of the nodes participating in the multi-step process.) The computer system may then process the path data and the feedback data to update (or generate) a model that indicates confidence scores for one or more of the nodes involved in the multi-step process. In some embodiments, this model is built using artificial intelligence techniques, which may include, in some cases, machine learning algorithms and/or deep learning algorithms. In various embodiments, the computer system identifies nodes that do not satisfy a specified quality threshold and then recommends corrective actions for those nodes. The phrase “quality threshold” is broadly used herein to refer to any measurement that can be used to classify performance of a node (e.g., whether the node is associated with too many failing instances that include that node, which might cause paths that include that node to be flagged as potentially problematic). (One example of a quality threshold is a minimum score that must be achieved based on a specified quality algorithm, where score is lowered based on a failure rate of the node.) In some embodiments, the computer system processes instance data relating to an in-progress instance of the multi-step process and uses the confidence scores to determine whether a corrective action should be taken while the instance is in-progress.

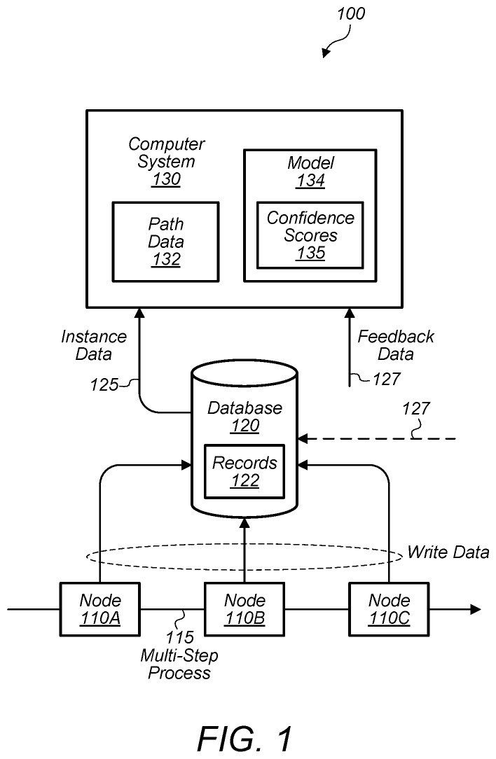

These techniques may be advantageous over prior approaches as these techniques allow for nodes in a multi-step process to be evaluated for issues. Said differently, these techniques may allow for a large amount of variables associated with complex multi-step processes to be evaluated and used to determine those nodes having issues, when it might otherwise be difficult to assess what it causing those issues. These issues may include, for example, theft, damage, fraud, tainted goods, food poisoning, spoilage, bias (e.g., treating one entity more favorable than another), etc. These techniques may also help determine issues before those issues become overwhelming—i.e., determines issues at an earlier point in time relative to when such issues would be realized. Additionally, these techniques may identify unknown associations (e.g., storage temperature related to computer chip failures). Moreover, in various cases, the trust in a multi-step process may be built across multiple nodes using these techniques, which may allow for an overall improvement in the quality of output from the process. A system for implementing these techniques will now be discussed below, starting with FIG. 1.

Turning now to FIG. 1, a block diagram of a system 100 is shown. System 100 is a set of components that are implemented via hardware or a combination of hardware and software routines. In the illustrated embodiment, system 100 includes nodes 110A-C, a database 120, and a computer system 130. As depicted, computer system 130 includes path data 132 and a model 134 having confidence scores 135. Also as depicted, database 120 includes records 122. While database 120 is shown as being separate from nodes 110 and computer system 130, in various embodiments, database 120 is a distributed database that is replicated across databases of nodes 110 and computer system 130. In some embodiments, system 100 is implemented differently than shown—e.g., confidence scores 135 may be stored in records 122.

Nodes 110, in various embodiments, are entities involved in performing the actions of steps in a multi-step process 115. Nodes 110 may be, for example, computer systems such as network routers that route network traffic. In some instances, nodes 110 may broadly represent enterprises, including all the components of those enterprises (e.g., the employees and systems of those enterprises). For example, in a multi-step process 115 that involves the distribution of pineapples, the farm that produces the pineapples, the distributer that ships the pineapples, and the store that sells the pineapples may each be considered a node 110.

In various embodiments, a multi-step process 115 includes a set of steps having actions that are taken in order to achieve a particular end. In various embodiments, a multi-step process 115 is associated with multiple nodes 110 that are responsible for performing the steps defined in that process 115. The particular nodes 110 involved in a given instance/execution of a multi-step process 115 may vary from those involved in another instance of the same particular multi-step process. Returning to the pineapple example, while the particular distributer and store may be the same, one shipment of pineapples may come from one farm in one instance, while another shipment may come from a different farm in a different instance. In another example, a multi-step process 115 may involve the treatment of patients suffering from a similar illness where the steps in that multi-step process correspond to different stages in the treatment of that illness. Accordingly, the same step in the healing process may involve, from one patient to the next, different doctors and nurses, who may be represented as nodes 110 associated with that step. Thus, in some embodiments, a multi-step process 115 is implemented by a group of nodes 110 in which a given set of nodes 110 in that group participate in a particular instance of that multi-step process 115. Moreover, the steps in a multi-step process 115 may vary where one instance has more steps than another—e.g., a particular patient may need another round of treatment. In various embodiments, nodes 110 may write data to database 120 that relates to their involvement in a multi-step process 115.

Database 120, in various embodiments, is a data repository for storing records 122 that are written by one or more nodes 110. In some embodiments, database 120 includes multiple data repositories that are maintained by different entities (e.g., nodes 110 and computer system 130). Accordingly, database 120 may be implemented as a distributed ledger. That is, records 122 may be replicated across multiple data repositories such that entities involved in a process 115 may maintain their own copy of records 122. In some embodiments, the distributed ledger is a blockchain, where records 122 may be entire chains or blocks within those chains.

In various embodiments, records 122 provide information relating to the instances of a multi-step process 115. In some embodiments, a given record 122 corresponds to a particular step and provides information about what occurred in that step and the various states related to that step. Returning to the pineapple example, a particular record 122 written by the distributor may indicate when the pineapples were picked up from the farm, when they were dropped off at the store, and the condition that they were in at the various stages of the step. Accordingly, a set of records 122 may provide information relating to a particular instance of the multi-step process. In various embodiments, records 122 are retrieved by computer system 130 so that it may update (or create) a model for evaluating the nodes 110 that are involved in a multi-step process 115.

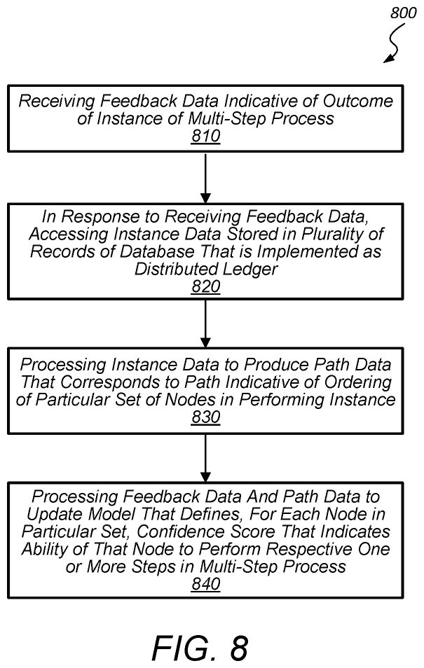

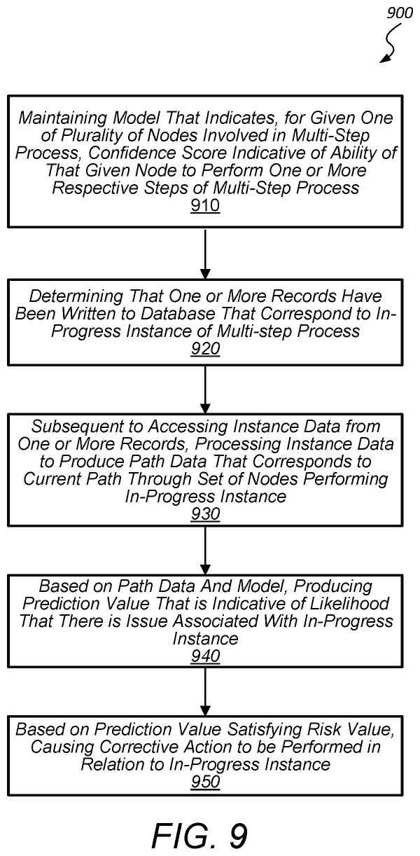

Computer system 130, in various embodiments, evaluates the nodes 110 in a multi-step process 115 and uses that evaluation to suggest corrective actions for those nodes 110 having poor scores. In some embodiments, computer system 130 implements a server-based platform capable of storing data for multiple users and using that data to build a model 134. Accordingly, computer system 130 may be, for example, a multi-tenant database system such as the multi-tenant database system discussed in detail below with respect to FIGS. 8 and 9.

In various embodiments, computer system 130 builds a model 134 that indicates confidence scores 135 for nodes 110. A confidence score 135, for a given node 110, may indicate a level of trust in that node as an actor in a multi-step process 115. As an example, a low confidence score 135 for a particular node 110 may indicate that there is low trust in that node's ability to perform its assigned set of steps in a particular multi-step process 115. As such, in various embodiments, a low confidence score 135 for a node 110A, for example, is indicative of node 110A being associated with issues that occur in a multi-step process 115—e.g., node 110A may be a distributor that often delivers crushed pineapples to a store or, in a multi-step process 115 involving hiring new employees, node 110A may be a headhunter that suggests individuals that have historically performed poor for the companies that have hired them. In various embodiments, computer system 130 may use model 134 to make predictions on multi-step processes 115 that are in-progress. Such predictions may result in corrective actions being performed with respect to a process 115. For example, a prediction about a shipment of pineapples possibly being crushed may cause computer system 130 to recommend to a particular node 110 (e.g., a seller) that the shipment be inspected at its step in the process 115. In another example, computer system 130 may recommend to a company that is using the bad headhunter mentioned above to fire that headhunter. In various embodiments, computer system 130 utilizes a set of AI-based algorithms (e.g., deep learning and machine learning algorithms) to generate (or update) model 134 and to also produce predictions based on model 134. Generating model 134 and producing the predictions may be broken down into a learning phase and an enforcement phase.

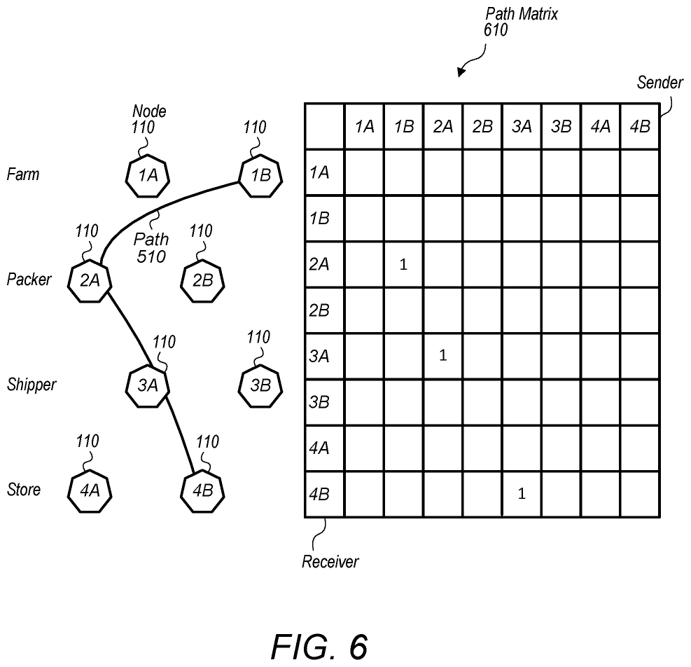

In the learning phase, computer system 130 may perform (using AI-based algorithms) an analysis on a set of instances of a particular multi-step process 115. In various embodiments, computer system 130 processes data (e.g., path data 132, feedback data 127, and other data) about nodes 110, their actions, and the outcomes of instances to assign confidence scores 135 to the nodes 110 involved in those instances. Accordingly, computer system 130 may retrieve instance data 125 from one or more records 122, which describe a particular instance. In some embodiments, computer system 130 then processes instance data 125 to produce path data 132. Path data 132 may correspond to a path taken through the nodes 110 involved in the particular instance. For example, path data 132 may detail a path through a farmer, a distributor, and a seller by which a shipment of pineapples has traveled. As another example, path data 132 may detail a path through the doctors and nurses involved in the treatment of a patient—e.g., the doctor that diagnosed the patient, the surgeon that operated on the patient, and the nurses that administered drugs to the patient. In various embodiments, path data 132 is structured in a format (e.g., a matrix format as discussed below with respect to FIG. 6) that can be fed into the AI-based algorithms for analysis.

Computer system 130 may further obtain feedback data 127 indicating an outcome for the particular instance. Feedback data 127 may indicate an outcome up to a certain point in an in-progress instance. For example, if a shipment of pineapples is inspected at the distributor and is found to be good, then feedback data 127 may indicate a success up to the point where the distributor inspected the shipment. Moreover, in various embodiments, feedback data 127 indicates a spectrum of outcomes (e.g., complete failure, complete success, a success but a few issues, etc.). As an example, a shipment of apples may be a little bruised, which indicates that the shipment itself was successful, but there were a few issues (i.e., a little bruised). In various embodiments, the confidence score 135 assigned to a node 110 may be based on the severity of the outcome—e.g., a lower score for a worse outcome than an okay one. Feedback data 127 may also indicate an outcome for a specific aspect of an instance. For example, a shipment of cookies may arrive without damage and thus have a positive outcome for the transportation aspect, but may fail a “nut-free” measure and thus have a negative outcome with respect to that aspect. In some cases, a node 110 may be assigned a confidence score 135 for each aspect that it is involved in—e.g., a score 135 for transportation, a score 135 for testing, etc.

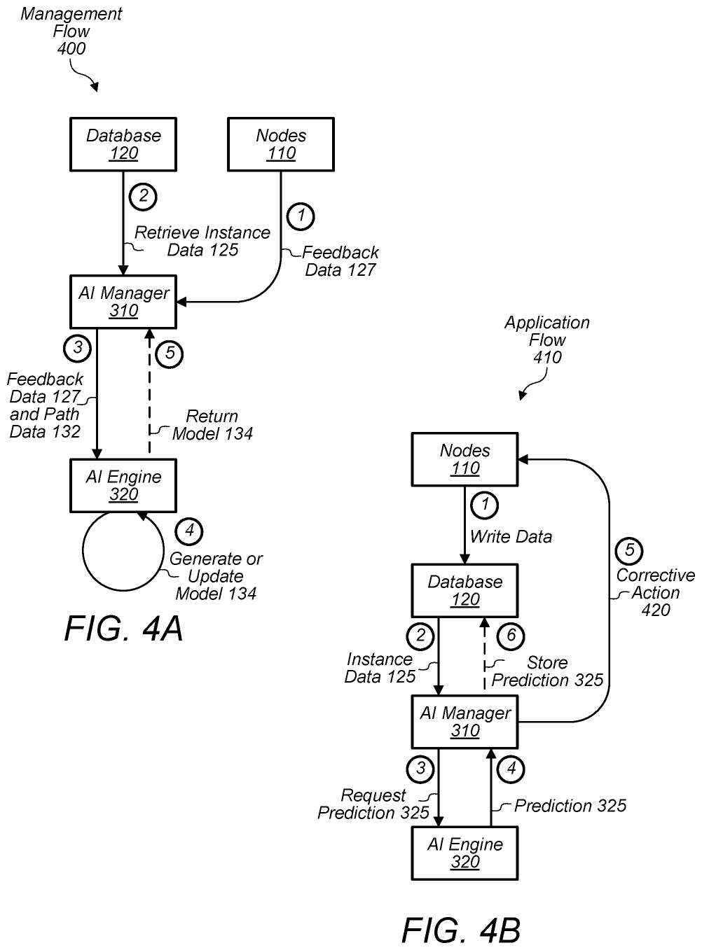

In various embodiments, path data 132 and feedback data 127 may allow the AI-based algorithms to draw conclusions about nodes 110 and their involvement in the particular instance and then to assign confidence scores 135 based on those conclusions. For example, nodes 110 involved in the particular instance may be assigned lower confidence scores 135 if the outcome of that instance is negative or a failure—e.g., a shipment of pineapples were crushed. The particulars of the learning phase are discussed in more detail below with respect to FIG. 4A.

In the enforcement phase, computer system 130 may produce (using the AI-based algorithms) one or more predictions about instances of a multi-step process 115 based on model 134. In various embodiments, as a particular instance is in-progress, nodes 110 may be writing data about their involvement to database 120. Accordingly, this data may be passed to computer system 130 so that system 130 may analyze the data to produce predictions about the particular instance. In various cases, computer system 130 may determine, based on model 134, that the particular in-progress instance exhibits properties associated with a negative or failed outcome. Thus, computer system 130 may recommend that a corrective action be taken to determine whether an issue has occurred in the particular instance. For example, computer system 130 may determine from data written by a distributor that the distributor has taken (or not taken) actions that usually result in a shipment of pineapples being crushed. Accordingly, based on the confidence score 135 of the distributor and the written data, computer system 130 may recommend to the next node 110 in the multi-step process 115 that it inspect the pineapple shipment for issues. The particulars of the enforcement phase are discussed in more detail below with respect to FIG. 4B.

In one example implementation of system 100, a group of nodes 110 may be involved in a multi-step process 115 that pertains to distributing computer chips from manufacturers in China to United States stores. In this example implementation, different sets of nodes 110 (e.g., different manufacturers, shippers, sellers, etc.) may be involved in performing multiple iterations of the multi-step process in which each iteration involves distributing a set of computer chips. As a given set of nodes 110 performs an instance, those nodes may write instance data 125, detailing when they received the set of computer chips, when they dropped the computer chips off, and the conditions of the warehouses, trucks, etc. in which the computer chips were stored in (as a few examples). A computer system 130 may access this instance data 125 and process the data to produce path data 132 that can be fed into AI-based algorithms. Computer system 130 may also access feedback data 127 indicating the outcome of each instance (e.g., the computer chips were delivered in good condition, the computer ships were replaced with fakes, the computer chips were water damaged, etc.).

Based on path data 132 and feedback data 127, computer system 130 may generate a model 134 that indicates a confidence score 135 for each node 110. In cases where feedback data 127 indicates a negative outcome for an instance, computer system 130 may decrease the confidence score 135 of each node 110 involved in that instance. In some cases, feedback data 127 may be provided during an in-progress instance and indicate a negative outcome. As such, computer system 130 may decrease the scores 135 for the nodes 110 that have participated in the in-progress instance up to the point where feedback data 127 was provided, which may not include the particular node 110 that provided feedback data 127. For example, a distributor may test a shipment of apples that it receives directly from a farmer. In the case that the apples are rotten, the distributor may provide feedback data 127 indicating a negative outcome and only the farmer may receive a lower score 135. This may incentivize nodes 110 to inspect what they receive form another node 110 so that they do not receive a lower score 135 as result of another node's 110 negligence.

Overtime, a particular node 110 may be develop a confidence score 135 that is below a desired quality threshold (e.g., that node 110 has been associated with too many failed outcomes for delivering computer chips). In some embodiments, a confidence score 135 is tied to a particular type of instance (e.g., delivering apples versus computer chips) of a multi-step process 115. For example, a node 110 may perform a great job with transporting computer chips from China, but a bad job with shipping pineapples during the summer. Thus, in this example implementation, computer system 130 may instruct another node 110 to inspect the computer chips that are received from the particular node 110 for problems because that particular node 110 has an unsatisfactory confidence score 135 with respect to shipping computer chips. In some cases, computer system 130 may determine that an in-progress instance exhibits attributes associated with failing outcomes. For example, a particular distributor may ship its bad computer chips to a particular store and thus that store may receive negative feedback from its customers. In such cases, computer system 130 may determine that a shipment of computer chips is moving from the particular distributor to the particular store and thus may recommend a corrective action to the store such as inspecting the computer chips. In implementing this example, computer system 130 may provide a way to discover the particular nodes 110 that are causing issues in a multi-step process 115. The particulars of database 120 will now be discussed in greater detail.

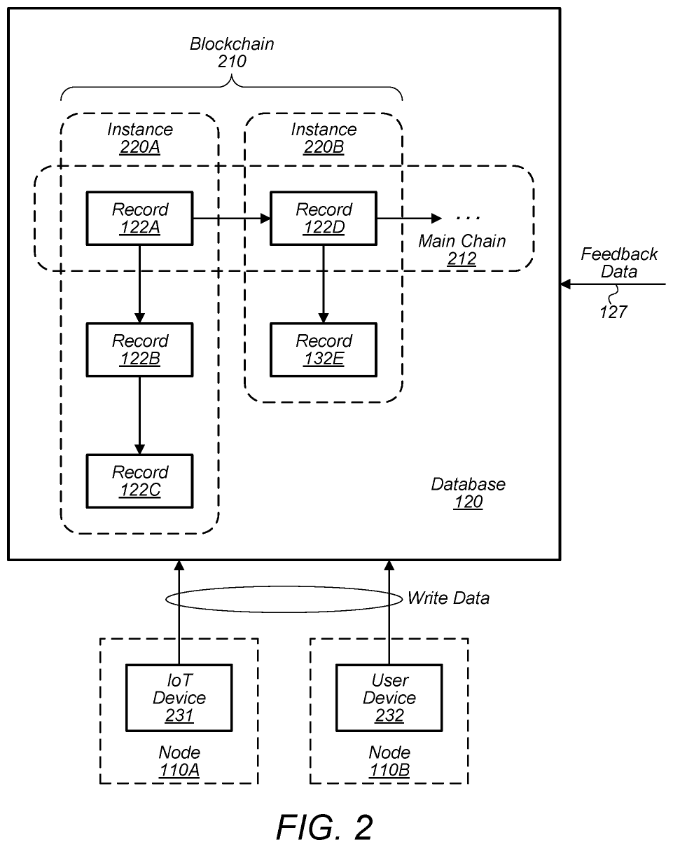

Turning now to FIG. 2, a block diagram of an example database 120 is shown. In the illustrated embodiment, database 120 includes a blockchain 210 having records 122. As shown, records 122A-C are associated with an instance 220A, and records 122D-E are associated with an instance 220B. As further shown, node 110A includes an Internet of Things (TOT) device 231 and node 110B includes a user device 232 (via which a user provides input), both of which are capable of writing records 122 to a database 120. In some embodiments, database 120 may be implemented differently shown—e.g., database 120 may store records 122, but not as a blockchain 210.

As mentioned earlier, an instance of a multi-step process 115 may be associated with a path taken through the nodes 110 of that instance. For example, a particular instance may start with a farmer and then may move to a distributor followed by a seller. Accordingly, it may be desirable to track the path taken in an instance while also preventing data about that path from being manipulated after it has been written. Thus, in some embodiments, nodes 110 write data to database 120 as records 122 in a blockchain 210. Accordingly, while database 120 is shown as a single unit, in various embodiments, database 120 is a group of database repositories that implement a distributed ledger (e.g., blockchain 210). Thus, nodes 110 and computer system 130 may each maintain their own database repository that stores copies of records 122, which are decentralized, distributed, and public to those nodes 110 and computer system 130.

Blockchain 210, in various embodiments, includes a set of records 122 that are linked and secured using cryptographic algorithms. In various embodiments, blockchain 210 includes multiple instances of a multi-step process 115. Each one of these instances may be a series of records 122 that extend off a main chain 212 of blockchain 210—e.g., a sub-chain. As shown, for example, records 122A and 122D may be a part of the main chain 212, where record 122A starts a sub-chain of records (e.g., records 122A-C) corresponding to instance 220A. Viewed differently, records 122 of main chain 212 may themselves be part of their own blockchain. In some embodiments, blockchain 210 corresponds to a particular instance of a multi-step process 115 and thus database 120 may store records 122 on multiple blockchains 210 for the same process 115—one for each instance of that process. In some embodiments, records 122 may be stored as smart contracts on main chain 212. As used herein, the term “smart contract” is used in accordance with its well-understood meaning in the art and refers to a computer program that is stored on a blockchain and, when executed, digitally facilities, verifies, or enforces the negotiation of a contract. Accordingly, for a given instance of a process 115, a smart contract may be written to blockchain 212 that establishes a contract between all parties involved in that instance. Each party (e.g., node 110, computer system 130, etc.) may then write data about their involvement in the given instance to the smart contract.

As indicated above, in various embodiments, records 122 are written by nodes 110 that are involved in instances of a multi-step process 115. While nodes 110 may write records 122, in various embodiments, the sources of the data in those records 122 vary. For example, node 110A includes an IoT device 231 (e.g., a sensor device) that may take temperature readings in a food truck that is transporting pineapples. IoT device 231 may provide various types of data including, for example, images of apples for assessing their rottenness. These types of data (e.g., temperature readings, images, etc.) may be written by node 110A to a record 122 that corresponds to its particular step—e.g., a step of transporting pineapples from a farmer to a store. As shown, however, node 110B includes a user device 232 that may provide information received from a user, which gets written by node 110B as a record 122—e.g., the user may indicate when the pineapples were picked up from the farmer and when they were dropped off.

The particular information that may be written in a record 122, in various embodiments, is defined by the entity that sets up a particular blockchain 210 (as opposed to a group of nodes 110 that are associated with a blockchain 210 agreeing upon what data can be written). For example, the store that sells pineapples might set up a blockchain 210 and indicate that certain information (e.g., when a node 110 picked up pineapples from the previous node 110, what tests that node 110 performed on the pineapples, when that node 110 dropped off the pineapples at the next node 110, etc.) may be written in a record 122. In some embodiments, since computer system 130 analyzes records 122, a user of computer system 130 may define what information can be written in a record 122. In some cases, what information can be provided may be defined by a smart contract.

Because records 122 may be viewable by any member who can access blockchain 210, in various embodiments, some or all the data written in records 122 is encrypted. In particular, a node 110 may provide information that it does not want to be known by a possible competitor but is helpful in building model 134. As an example, the type of cocoa used in chocolate chips may be a special blend that the chocolate chip manufacturer does not want to reveal to a muffin manufacturer. But the muffin manufacturer may sell “nut free” muffins that includes chocolate chips made by the chocolate chip manufacturer using nut-based ingredients (which is unknown to the muffin manufacturer). The muffin manufacturer may also receive chocolate chips from other manufactures. Accordingly, when the muffin manufacturer receives bad reviews because its muffins are not “nut free”, then system 130 may need to analyze the individual ingredients to determine that the chocolate chip manufacturer, which is using the nut-based ingredients, is causing the issue. In embodiments in which encrypted data is written to blockchain 210, system 130 may be provided with one or more cryptographic keys (e.g., one from each node 110) for decrypting that data so that the data may be fed into an AI-based algorithm.

By writing data to blockchain 210, that data may be protected from being manipulated and the path for a particular instance may be preserved. That is, as a multi-step process 115 is in progress, each node 110 may write a block (e.g., a record 122) to blockchain 210 and as the number of blocks increase, the ability to alter earlier blocks becomes computationally difficult (and eventually infeasible). Accordingly, a node 110 may not be able to change earlier written data or the path through an instance (e.g., change to say that manufacturer A baked the cookies instead of manufacturer B). Thus, computer system 130 may have some assurance that the data written to blockchain 210 is valid and has not been manipulated. The particulars of computer system 130 will now be discussed below.

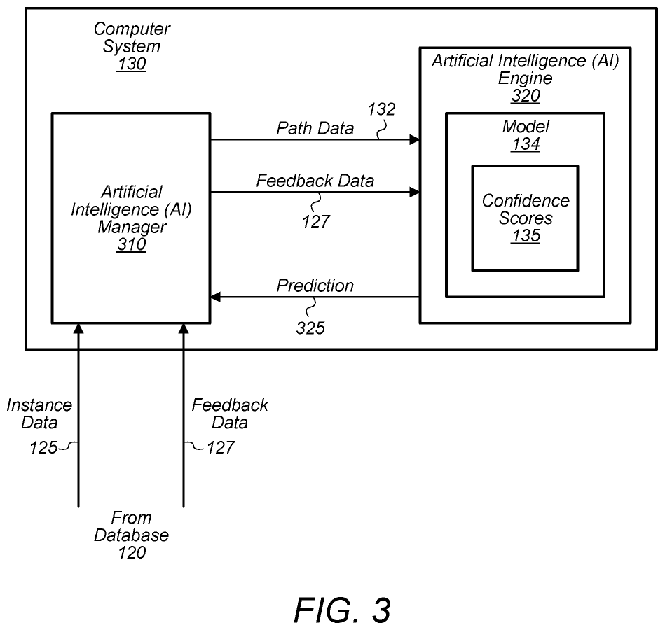

Turning now to FIG. 3, a block diagram of an example computer system 130 is shown. In the illustrated embodiment, computer system 130 includes an artificial intelligence manager 310 (referred to as AI manager 310) and an artificial intelligence engine 320 (referred to as AI engine 320). In some embodiments, AI manager 310 and AI engine 320 are implemented via hardware that is configured to perform their intended functionality; in other embodiments, AI manager 310 and AI engine are software routines that are executable by hardware. While model 134 may remain in AI engine 320 or be stored in the file system of computer system 130, in various embodiments, model 134 is stored in database 120 and is passed to AI engine 320 when appropriate. In some embodiments, computer system 130 may be implemented differently than shown—e.g., feedback data 127 may be retrieved by computer system 130 from database 120.

AI manager 310, in various embodiments, facilitates the management of AI engine 320, which includes preparing instance data 125 and feedback data 127 for processing by AI engine 320 so that it can build model 134. AI manager 310 may also facilitate the performance of one or more corrective actions with respect to nodes 110. For example, AI manager 310 may notify a particular node 110 about a shipment that may be problematic or that a certain recommended candidate for hiring should be avoided. In various embodiments, AI manager 310 uses triggers to determine when to perform particular routines. AI manager 310 may, for example, initiate a management flow (discussed with respect to FIG. 4A) in response to receiving/obtaining feedback data 127 or initiate an application flow (discussed with respect to FIG. 4B) in response to detecting new records 122 on blockchain 210.

After detecting the occurrence of a trigger, in some embodiments, AI manager 310 then accesses database 120 to retrieve instance data 125 from records 122. In some cases, instance data 125 may be in a raw format that cannot be processed by AI engine 320—i.e., is not in the correct format for being fed into an AI-based algorithm. Accordingly, in various embodiments, AI manager 310 processes instance data 125 to produce path data 132, which is structured into a format that can be processed by AI engine 320 and that causes AI engine 320 to evaluate the path for that instance. For example, AI engine 320 may use a support vector machine algorithm to build model 134, but instance data 125 may initially be an unstructured list of values. Thus, AI manager 310 may format the values in that unstructured list into a set of vectors that can be fed into the support vector machine algorithm. In some cases, AI engine 320 may further label instance data 125 as a success or a failure based on feedback data 127. In this manner, manager 310 may provide a supervised learning environment for AI engine 320.

After producing path data 132, in various embodiments, AI manager 310 provides path data 132 and model 134 to AI engine 320. AI manager 310 may, in various cases, provide that information as a request to AI engine 320 for updating (or creating) model 134—as part of the learning/management flow discussed below with respect to FIG. 4A. In such cases, AI manager 310 may additionally provide feedback data 127, which may have been initially received via a supported API or a user interface. AI manager 310 may, in other various cases, provide path data 132 and model 134 as a request to AI engine 320 for producing a set of predictions 325—as part of the enforcement/application flow discussed below with respect to FIG. 4B. In various embodiments, a prediction 325 indicates a likelihood that an instance will be associated with a problem and thus a failed outcome. Based on a received prediction 325 indicating a very high likelihood that a certain instance will fail, AI manager 310 may facilitate the performance of a corrective action to determine if that is actually the case. For example, a prediction 325 for a shipment of apples may indicate that there is a high likelihood that the apples have spoiled and thus AI manager 310 may instruct the next node 110 in that instance to inspect the apples.

AI manager 310 may be advantageous to the techniques that are described herein as it implements an interface between blockchain 210 and AI engine 320. In particular, AI manager 310 enables data written in a particular format to blockchain 210 to be converted into a different format that can be understood by AI engine 320. By enabling AI engine 320 to understand the data written to blockchain 210, AI manager 310 may allow for AI engine 320 to classify that data in building model 134 and for the correct “question” (e.g., a question pertaining to whether an instance will fail) to be posed to AI engine 320 so that AI engine 320 may produce prediction 325. Moreover, AI manager 310 enables a blockchain 210 to be used in various embodiments and thus the techniques that are described herein may receive the benefits of blockchain (e.g., immutable transactions, decentralization, etc.).

AI engine 320, in various embodiments, implements AI-based algorithms for analyzing data, building a model 134 that scores nodes 110 based on that data, and providing predictions 325 about instances of a multi-step process 115. AI engine 320 may be, for example, SALESFORCE's EINSTEIN. When building a model 134 (during a learning phase), AI engine 320 may receive path data 132 and feedback data 127 from AI manager 310; however, when producing a prediction 325 (during an enforcement phase that can overlap with the learning phase), AI engine 320 may receive only path data 132.

When building model 134, AI engine 320 may look for correlations between successful instances and path data 132 (along with correlations between unsuccessful instances and path data 132). In cases where AI engine 320 implements a classification algorithm, AI engine 320 may classify path data 132 into two categories: successes and failures. Since, in various cases, AI engine 320 receives feedback data 127, AI engine 320 may determine which instances are successes and which are failures, and thus determine which outcomes the values in path data 132 result in. In various cases, AI engine 320 may determine that the strength of the validation performed at each stage of a multi-step process 115 is one of multiple metrics that provides an indication of whether an instance will be successful. For example, if nodes 110 of an instance perform laboratory testing on the products that they receive, then that may be a good indication that the instance will be successful. But if those nodes 110 do not perform any sort of inspection on what they process, then that may be a good indication that the instance will fail. As another example, in a multi-step process 115 involving patent filings, a node 110 (e.g., a senior patent attorney) that spends 10 minutes reading a patent draft may be a good indication that the draft has not been thoroughly reviewed and thus is likely to be filed with issues.

AI engine 320 may also assign confidence scores 135 to the nodes 110 of a multi-step process 115. In various embodiments, these confidence scores 135 are calculated based on the outcomes of the instances of a process 115. For example, if an particular instance resulted in a failure, then all nodes 110 that participated in that instance may lose points on their score 135. The amount lost, however, may depend on certain conditions and may vary between nodes 110. In some embodiments, the conditions that affect the amount lost are based on environmental factors such as weather. For example, extra hot days in the summer may cause produce to spoil in more shipments than usual. Accordingly, nodes 110 may not be penalized as much. In various cases, nodes 110 may be penalized differently. For example, in a failed instance, a particular node 110 that performed laboratory testing may have their score 135 decreased less than another node 110 that only inspected the shipment. Confidence scores 135, in various embodiments, are built up over time where successes lead to a better score and failures lead to a worse score. Thus, a node 110 that is associated with a high confidence score 135 may be trusted to perform its role in a manner that leads to a successful instance. In various embodiments, confidence scores 135 are used (along with other potential metrics) to classify in-progress instances. Over time, AI engine 320 may develop a model 134 that can be used to accurately classify an in-progress instance as likely to succeed or fail.

When producing a prediction 325, in various embodiments, AI engine 320 classifies an in-progress instance as likely to succeed or fail based on model 134. In particular, AI engine 320 may determine whether the attributes defined by path data 132 for the in-progress instance correspond more to those associated with a success or a failure. For example, model 134 may indicate that shipments between two particular nodes 110 almost always result in a failure and thus in response to the in-progress instance involving a shipment between those nodes 110, AI engine 320 may produce a prediction 325 that indicates that the in-progress instance is likely to fail. In some embodiments, prediction 325 indicates a predicted outcome and a percentage that the prediction is correct. If the predicted outcome is negative with a high percentage that indicates a confidence in the prediction, AI manager 310 may perform a corrective action.

In some embodiments, AI engine 320 further evaluates whether the data written to the records 122 in database 120 is valid. In some cases, a node 110 may provide false information, either knowingly or because they themselves were being duped. Accordingly, AI engine 320 may assign a level of confidence to data written to database 120 based on various metrics. For example, in some cases, if a particular node 110 has a low confidence score 135, then AI engine 320 may assign a low level of confidence to the data that is written by that node 110. Thus, if two nodes 110 provide conflicting information (e.g., one node 110 records that the produce it dropped off was at 75 degrees Fahrenheit and another node 110 records that the produce was at 85 degrees Fahrenheit when it was picked up), then computer system 130 may trust one of those nodes 110 (e.g., the node with the higher confidence score 135) and initiate a corrective action to inspect the other node 110.

Turning now to FIG. 4A, a block diagram of an example management flow 400 is shown (referred to above as the learning phase). In the illustrated embodiment, flow 400 includes nodes 110, database 120, AI manager 310 and AI engine 320. In some embodiments, flow 400 is implemented differently than shown. For example, feedback data 127 may be received from a different entity than a node 110 such as a user writing a review on a forum.

Management flow 400, in various embodiments, enables the building (i.e., the creation or modification) of model 134. As shown, management flow 400 begins with AI manager 310 receiving feedback data 127—this is example of a trigger as discussed earlier. Feedback data 127 may be received from a website via which a user submitted a review, a store that performed a quality review, an IoT device, etc. As an example, a customer may write a 1-star review for a product that was defective, indicating a negative outcome for the instance of the process 115 that produced that product. As another example, a restaurant may perform a quality test on a batch of strawberries and file a complaint upon determining that the strawberries have spoiled despite being recently purchased from a farm. In some embodiments, AI manager 310 performs pre-processing on feedback data 127 to determine whether it is positive or negative so that the corresponding instance data 125 can be appropriately labeled. For example, AI manager 310 may deduce from the negative language used in a review that a customer is not satisfied with a product and thus AI manager 310 may associate the corresponding instance with a negative outcome.

After receiving (or obtaining) feedback data 127, in various embodiments, AI manager 310 retrieves instance data 125 from records 122 stored in database 120. In various instances, feedback data 127 may specify (or be associated with) a particular instance via, for example, a serial number. Accordingly, the instance data 125 that corresponds to feedback data 127 may be retrieved based on feedback data 127 (e.g., using a serial number indicated by feedback data 127). After instance data 125 has been retrieved, in some embodiments, AI manager 310 then processes that instance data 125 to produce path data 132 that may be fed into AI engine 320 as discussed above. AI manager 310 may further retrieve model 134 from a local data store or database 120. After retrieving model 134 and processing instance data 125 (and, in some cases, feedback data 127 to determine how to label instance data 125), AI manager 310 may then pass model 134, path data 132, and/or feedback data 127 to AI engine 320.

In various embodiments, AI engine 320 processes that provided information to update (or to create a new) model 134 as discussed earlier. This may involve tweaking parameters of model 134 such as confidence score 135 in order to improve predictions 325. In the context of a support vector machine, AI engine 320 may adjust the boundary that is used to determine if an instance should be classified as a success or failure. Accordingly, processing the provided information may involve AI engine 320 running AI-based algorithms (e.g., machine or deep learning-based algorithms) for building model 134. In various embodiments, after model 134 has been created or updated, AI engine 320 returns model 134 to AI manager 310, which may then store model 134 in a database such as database 120 for retrieval in management flow 400 or an application flow.

Turning now to FIG. 4B, a block diagram of an example application flow 410 is shown (referred to above as the enforcement phase). In the illustrated embodiment, flow 410 includes nodes 110, database 120, AI manager 310, and AI engine 320. In some embodiments, flow 410 is implemented differently than shown—e.g., prediction 325 may not be stored at database 120 as shown.

Enforcement flow 410, in various embodiments, enables the evaluation of an instance and the nodes 110 that are involved in that instance. As shown, enforcement flow 410 begins with one or more nodes 110 writing data in records 122 of database 120. For example, a node 110 may write data indicating that it received an item (e.g., data, a product, etc.) from another node 110. Because database 120 may be a group of data repositories that store data replicated across those repositories, AI manager 310 may detect a change to a local repository that is part of the group. Accordingly, this change may trigger AI manager 310 to retrieve instance data 125, which includes the change, from database 120. In some embodiments, another entity may notify AI manager 310 that new instance data 125 is available for processing. After processing instance data 125 to produce path data 132, AI manager 310 may send a request for a prediction 325 to AI engine 320. In various embodiments, this request includes path data 132 and model 134.

In various embodiments, AI engine 320 processes the provided path data 132 based on model 134 to determine a level of risk for the corresponding in-progress instance. This level of risk may indicate a likelihood that there is an issue with that instance. As mentioned earlier, AI engine 320 may classify path data 132 into a classification that may include at least a failure and a success classification. In various embodiments, such a classification is further based on the confidence scores 135 of the nodes 110 involved in that instance. Accordingly, AI engine 320 may, in some cases, classify the in-progress instance under the failure classification with a certain level of assurance (e.g., a percentage value indicative of the chance that the prediction is correct). In various embodiments, AI engine 320 provides the determine level of risk to AI manager 310 as prediction 325.

Based on prediction 325, in various embodiments, AI manager 310 determines whether to initiate a corrective action 420. For example, if the level of risk indicated by prediction 325 exceeds an accepted threshold value, then AI manager 310 may initiate action 420. To initiate corrective action 420, AI manager 310 may cause a particular node 110 to perform some action in relation to the other nodes 110. For example, the instance involves the distribution of goods from a sender to a recipient, then AI manager 310 may instruct the recipient to inspect goods that are received from the sender for issues. In some embodiments, AI manager 310 stores the received prediction 325 in database 120. Since database 120 may be accessible to nodes 110, in some cases, nodes 110 may inspect prediction 325 and then choose to test the output of a previous node 110 if the prediction 325 is indicative of a potential negative outcome—thus a node 110 may decide to initiate a corrective action 420 without being instructed by AI manager 310. In some cases, a node 110 may be incentivized to perform a corrective action in order to show that it is not a cause of some issue—e.g., node 110 may test the outputs that it receives from a particular node 110. AI manager 310 later compares stored predictions 325 against any new predictions 325 to determine whether an in-progress instance is becoming progressively worse or better. In some embodiments, AI manager 310 encrypts predictions 325 before storing them so that nodes 110 cannot review them. In other embodiments, AI manager 310 stores unencrypted confidence scores 135 and predictions 325 so that nodes 110 may learn about how their being rated.

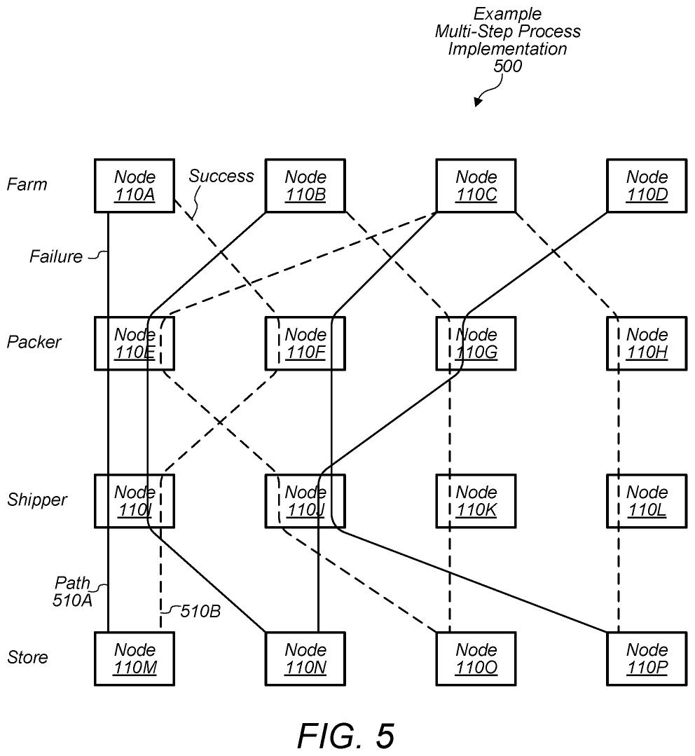

Turning now to FIG. 5, a block diagram of an example implementation 500 of a multi-step process 115. In the illustrated embodiment, example implementation 500 includes nodes 110A-D (each corresponding to a farmer), 110E-H (each corresponding to a packer), 110I-L (each corresponding to a shipper), 110M-P (each corresponding to a store). As further shown, different groups of nodes 110 are part of different paths 510. In various embodiments, example implementation 500 may be implemented differently than shown—e.g., different paths 510.

As shown, various paths 510 are associated with a failed outcome (e.g., path 510A) and various paths 510 are associated with a successful outcome (e.g., 510B). As discussed earlier, AI engine 320 may analyze path data 132 that corresponds to paths 510 (along with feedback data 127) to determine confidence scores 135 for nodes 110. In illustrated embodiment, nodes 110H, 110K, and 110L have participated in only successful paths 510 and thus model 134 may indicate a high confidence score 135 (e.g., greater than 90% confidence score) for those nodes 110. Node 110N, however, has participated in only failed paths 510 as depicted and thus model 134 may indicate a low confidence score 135 (e.g., less than 10% confidence score) for node 110N. AI manager 310, in various embodiments, may initiate a corrective action 420 in relation to node 110N in order to address what is causing the low confidence score. This corrective action 420 may be initiated independent of an in-progress instance.

In various cases, a route between two or more particular nodes 110 may result in only failed paths 510. As depicted, for example, shipments that move from node 110E to 110I have always resulted in failed outcomes. Accordingly, when producing a prediction 325 for an in-progress instance, AI engine 320 may determine, based on path data 132, that the shipment for that instance has moved (or is currently moving or will move) between those two nodes. Thus, AI engine 320 may provide a prediction 325 indicating that the in-progress instance should be reviewed as it has a high likelihood of being associated with an issue. Note that the issue may not be directly caused by the two nodes. In some cases, the issue may be due to an intermediary that operates between those two nodes, but is not visible to the process (e.g., an individual is stealing from trucks at a truck stop along the way between two nodes 110). Accordingly, the prediction 325 may implicate that the path between the two nodes 110 is associated with issues without inferring that the two nodes 110 are the cause.

Turning now to FIG. 6, a block diagram of an example path matrix 610 is shown. In the illustrated embodiment, path matrix 610 provides an indication of a path 510 taken through the nodes 110 of a multi-step process 115. As shown, path 510 involves nodes 110 that are labeled as “1B”, “2A”, “3A”, and “4B”. As further shown, the value “1” is placed into the appropriate boxes to indicate which nodes 110 that an instance has progressed between. For example, the box corresponding to “1B” as a sender and “2A” as a receiver includes a value of “1” indicating that path 510 goes from “1B” to “2A”. In various embodiments, path matrix 610 is passed to AI engine 320 as a matrix structure and may be part of path data 132, which is provided by AI manager 310. Path matrix 610 may allow AI engine 320 to determine which nodes 110 are involved in a given instance and the path that the multi-step process 115 has taken through those nodes.

Various non-limiting examples will be presented to provide a deeper understanding of the techniques described herein. In one non-limiting example, a truck stop is secretly swapping out cases of European Union honey as it is transported out of a New York City shipping center bound for the eastern states. Only a few stores may test the honey, but these stores may provide feedback data 127 indicating that the honey is of a lower grade than usual. Computer system 130 may over time lower the confidence scores 135 of the truck stops involved in the shipping of that honey. While the other truck stops may be involved in other successful shipments, the truck stop that is swapping out cases may be associated with mostly failed shipments. As such, computer system 130 may identify where testing should be required and, in this case, identify shipping nodes 110 that utilize the bad truck stop. Note that while the bad truck stop may be a node, in some cases, the bad truck stop is part of the path between two nodes that is identified by those two nodes in the data that they write to blockchain 210. Accordingly, computer system 130 may identify the bad truck stop as being a consistent data point associated with failed instances and thus computer system 130 may warn nodes 110 that use that bad truck stop. For example, computer system 130 may instruct the next company to inspect the honey when it receives it from the bad truck stop. In this example, computer system 130 may use the original tests by the few stores and the lack of testing on other shipments as input into its evaluation, which may involve evaluating the chain of custody and assigning lower scores 135 to nodes 110 using the untrustworthy routes/truck stop and higher scores 135 to those nodes 110 that were successful in providing the European Union honey.

In various cases, if a specific trucking company that is moving the honey has never had any of their shipments verified (no negative or positive feedback), then their confidence score 135 may be neutral. Accordingly, a store that receives honey from a particular node 110 that has a low or neutral confidence score 135 may prioritize that honey for testing. When an issue is identified, computer system 130 may flag all nodes 110 in the chain of custody for that order, and reduce the scores 135 for all nodes 110 that were involved. This may encourage others to start evaluating their chain to slowly narrow the source of a violation. Thus, trust in the process may be built across multiple nodes, not just one store node attempting to guess when they get good product.

In another non-limiting example, fifty farmers are part of a collective that supply lettuce to several cold storage companies that take their crop for distribution. A particular one of the storage companies is reallocating lettuce incorrectly to favor its own chain of restaurants. Over time, other restaurants may provide feedback that indicates that the lettuce that they receive is poor quality. Computer system 130 may allow the farmers to be able to see that their “quality feedback” was always poor when shipping through the bad cold storage company. In particular, computer system 130 may identify what results in higher scores (e.g., shipping lettuce through the other companies) and that the bad storage company was getting lower than average scores than the other companies. This may result in extra inspection of the bad storage company such that the farmers can identify their product chain of custody, which will protect their reputation.

In another non-limiting example, a muffin manufacturer purchases a set of ingredients from many nodes 110 that all claim to be pesticide free. One of the nodes 110 has a poor yield so that node 110 purchases from a neighbor who is not pesticide free and passes the ingredients off as its own. Someone becomes sick and traces it back to the muffin. Computer system 130 may use that one instance with potential future problems to start narrowing down the riskiest part of the supply chain and provide recommendations on where testing procedures would be most valuable to detect the issue sooner. In cases where other muffin manufacturers receive a set of ingredients from that node 110 and as a result, more people become sick. Then, because the confidence score 135 for that node 110 may be lowered each time, computer system 130 may determine that that node 110 should be inspected. In one variation to this example, nodes 110 may all be providing pesticide free ingredients, however, one shipping company used by several of the nodes 110 may wash the inside of their shipping containers with chemicals that then drip down onto the ingredients. Accordingly, computer system 130 may identify that one shipping company as a common point among nodes 110 that are associated with pesticides in their ingredients and thus recommend inspection of ingredients that flow through that shipping company.

In another non-limiting example, sick patients may go through different stages (e.g., diagnosis, surgery, etc.) in their treatment in which they interact with different people including nurses and doctors. One of the nurses, however, may be administering a certain drug to their patients that was not prescribed by a doctor. These patients may report feeling queasy while showing signs of unexplained illness. In this example, computer system 130 may identify that the troublesome nurse is associated with the queasy patients and works during a period of the day when small amounts of the certain drug have gone missing. Accordingly, computer system 130 may recommend that the patients associated with the troublesome nurse be tested.

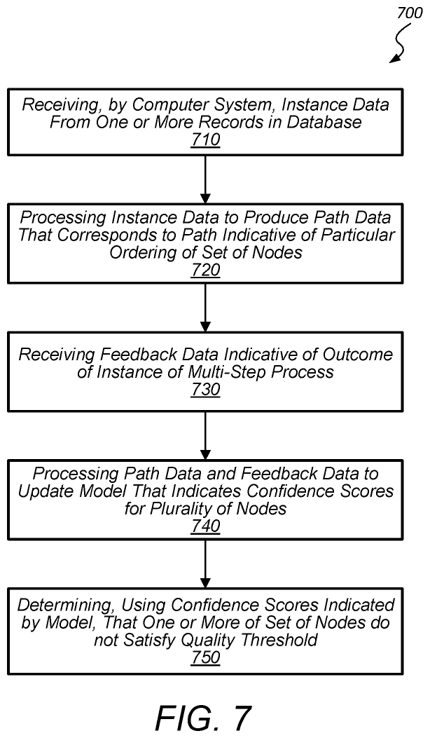

Turning now to FIG. 7, a flow diagram of a method 700 is shown. Method 700 is one embodiment of a method performed by a computer system (e.g., computer system 130) in order to evaluate nodes (e.g., nodes 110) writing to a database (e.g., database 120). Method 700 may include additional steps than shown—e.g., the computer system may cause a user interface to be presented to a user for receiving feedback data (e.g., feedback data 127).

Method 700 begins in step 710 with the computer system receiving instance data from one or more records (e.g., records 122) in the database. In some embodiments, the database is implemented as a distributed ledger such as a blockchain (e.g., blockchain 210) that is capable of storing records, for a given instance of a multi-step process (e.g., process 115), as a branch in that blockchain—the one or more records may represent a branch. The database may further be accessible by a plurality of nodes. In various embodiments, the instance data relates to an instance of a multi-step process and includes data written by a set of the plurality of nodes that perform the instance of the multi-step process according to a particular ordering. A portion of the one or more records that include the instance data may be written by a sensor device (e.g., IoT device 231) associated with a particular node in the set of nodes.

In step 720, the computer system processes the instance data to produce path data (e.g., path data 132) that corresponds to a path (e.g., path 510) indicative of the particular ordering of the set of nodes.

In step 730, the computer system receives feedback data indicative of an outcome of the instance of the multi-step process. In some cases, the feedback data may be received from a particular node in the set of nodes that corresponds to a recipient of a product or service that results from the multi-step process.

In step 740, the computer system processes both the path data and the feedback data to update (or create) a model (e.g., model 134) that indicates confidence scores (e.g., confidence scores 135) for the plurality of nodes. In some cases, the confidence scores may be based on the path taken (e.g., a path that travels between two nodes that has been associated with failures may result in lower confidence scores for shipments that move via that path). For example, a distributor that moves product through Asia and Europe may be receive a low confidence score with respect to shipments that move through Asia as such shipments are often replaced with fake product (whereas shipments that move through Europe are fine). The confidence scores may also be based on the time of year and the weather. In some embodiments, processing the path data and the feedback data includes performing a particular algorithm (e.g., a support vector machines (SVM)-based algorithm that analyzes data vectors for classification) using the path data and the feedback data as input into the particular algorithm. The particular algorithm may be one of a machine learning algorithm or a deep learning algorithm.

In step 750, the computer system determines, using confidence scores indicated by the model, that one or more of the set of nodes do not satisfy a quality threshold (e.g., a score that a node is expected to meet or exceed). The one or more nodes may not satisfy the threshold if they are associated with multiple instances of the multi-step process (or paths that are being used) that have a failing outcome. In response to determining that one or more of the set of nodes do not satisfy the quality threshold, the computer system may cause a particular node in the set of nodes to perform at least one corrective action (e.g., corrective action 420) in relation to the one or more determined nodes. For example, the computer system may instruct a store to inspect a particular batch of apples for defects. Accordingly, the multi-step process, in some cases, may involve a distribution of goods from a sender to a recipient, and thus the at least one corrective action may involve inspecting goods from at least one of the one or more nodes for one or more issues.

Turning now to FIG. 8, a flow diagram of a method 800 is shown. Method 800 is one embodiment of a method performed by a computer system (e.g., computer system 130) in order to update (or create) a model (e.g., model 134) that defines confidence scores (e.g., confidence scores 135) for nodes (e.g., nodes 110) involved in performing a multi-step process (e.g., multi-step process 115). Method 800 may be performed in response to a node (or other entity such as a user) providing feedback data (e.g., feedback data 127) for a certain instance of the multi-step process. In some embodiments, method 800 may include additional steps than shown—e.g., the computer system may synchronize a local repository with other repositories that are part of a distributed database (e.g., database 120).

Method 800 begins in step 810 with the computer system receiving feedback data that is indicative of an outcome of an instance of the multi-step process. In some cases, the feedback data may be indicative of a failed outcome.

In step 820, in response to receiving the feedback data, the computer system accesses instance data stored in a plurality of records (e.g., records 122) of a database. In various cases, the database may be implemented as a distributed ledger. The instance data may relate to the instance of the multi-step process and was written by a particular set of nodes that performed the instance. In some embodiments, the instance data is stored in an encrypted format and thus the computer system decrypts the instance data using a set of cryptographic keys associated with the particular set of nodes in order to produce a decrypted version of the instance data.

In step 830, the computer system processes the instance data to produce path data (e.g., path data 132) that corresponds to a path indicative of an ordering of the particular set of nodes in performing the instance.

In step 840, the computer system processes both the feedback data and the path data to update the model that defines, for each node in the particular set, a confidence score indicating an ability of that node to perform a respective one or more steps in the multi-step process. For example, a node with a low confidence score may indicate that the node fails more often than not to perform its respective steps—e.g., a store may often sell spoiled apples. The confidence score of a given node may be used to determine whether that node satisfies a quality threshold (e.g., whether the node is associated with a high fail to success ratio). In some embodiments, the computer system updates the confidence score for each node in the particular set to indicate a decrease in the ability of that node to perform the multi-step process. That is, the confidence score for a node may be reduced if that node is part of an instance that failed. The decrease in the ability of a first node in the particular set may be different than a decrease in the ability of a second node in the particular set. Said differently, the score reduction for one node may be greater (or lesser) than the score reduction experienced by another node. In some embodiments, the computer system accesses external data (e.g., environmental data) that indicates a set of factors (e.g., weather, time, stock prices, value of goods, etc.) that affect a flow of the instance and is usable to facilitate a reduced decrease in the confidence score of a given node in the particular set. That is, a node's score may not be reduced as much if the instance failed due to external factors such as cold weather or the driver on weekends being different and less skilled at managing the load than the driver who works during the week. In some embodiments, the computer system updates the confidence score for a given node in the particular set based on whether that given node performed one or more validation tests (e.g., performed a quality test) when performing the respective one or more steps associated with that node.

In various embodiments, the computer system accesses second instance data from a set of records in the database. This second instance data may relate to an in-progress instance of the multi-step process. In some embodiments, the computer system then processes the second instance data to produce second path data that corresponds to a path indicative of an ordering of a second particular set of nodes. Based on the second path data and the model, the computer system may determine that the in-progress instance involves one or more nodes that have a confidence score indicative of the one or more nodes not satisfying the quality threshold. Based on the one or more nodes not satisfying the quality threshold, the computer system may cause at least one corrective action to be performed in relation to the in-progress instance.

Turning now to FIG. 9, a flow diagram of a method 900 is shown. Method 900 is one embodiment of a method performed by a computer system (e.g., computer system 130) in order to produce a prediction (e.g., prediction 325) about an instance of a multi-step process (e.g., multi-step process 115). Method 900 may be performed by executing program instructions that are stored on a non-transitory, computer-readable medium. In some embodiments, method 900 may include additional steps than shown—e.g., the computer system may synchronize a local repository with other repositories that are part of a distributed database (e.g., database 120).

Method 900 begins in step 910 with the computer system maintaining a model (e.g., model 134) that indicates, for a given one of a plurality of nodes (e.g., nodes 110) involved in a multi-step process, a confidence score (e.g., confidence score 135) indicative of an ability of that given node to perform one or more respective steps of the multi-step process. For example, a node having a low confidence score may indicate that the node poorly performs (e.g. messes up, does not perform appropriate tests, etc.) its respective one or more steps.

In step 920, the computer system determines that one or more records (e.g., records 122) have been written to the database. The one or more records may correspond to an in-progress instance of the multi-step process and may be written by a set of the plurality of nodes that are performing the in-progress instance according to a particular ordering. In some cases, the one or more records may be part of a blockchain as the data store for the database.

In step 930, subsequent to accessing instance data (e.g., instance data 125) from the one or more records, the computer system processes the instance data to produce path data (e.g., path data 132) that corresponds to a current path (or portion which is known) through the set of nodes performing the in-progress instance. The current path may not be a complete path for the in-progress instance. For example, the current path may include a node for a farm and a node for a shipping company, but not a node for a store as the in-progress instance may not have reached that node yet.

In step 940, based on the path data and the model, the computer system produces a prediction value that is indicative of a likelihood that there is an issue associated with the in-progress instance. Producing that prediction value may include determining whether the set of nodes includes at least one node that has a confidence score that does not satisfy a quality threshold.

In step 950, based on the prediction value satisfying a risk value, the computer system causes a corrective action to be performed in relation to the in-progress instance. The multi-step process may involve the movement of data values between computer systems and thus the corrective action may include analyzing the data values to determine whether the data values have been corrupted.

In various embodiments, the computer system receives feedback data (e.g., feedback data 127) indicative of an outcome of a particular instance of the multi-step process that was performed by a particular set of the plurality of nodes. In response to receiving the feedback data, the computer system may access second instance data stored in a set of records of the database. The second instance data relates to the particular instance of the multi-step process and was written by the particular set of nodes that performed the particular instance. In some cases, the computer system provides an application programming interface (API) for receiving data (e.g., feedback data 127) that indicates outcomes of instances of the multi-step process. The feedback data may be received from a sensor device of a particular one in the set of nodes. In various embodiments, the computer system processes the second instance data to produce second path data that corresponds to a path indicative of an ordering of the particular set of nodes in performing the particular instance. Based on the feedback data and the second path data, the computer system may update the confidence scores indicated by the model where the confidence score of a given node is usable to determine whether that node satisfies a quality threshold.

Exemplary Computer System

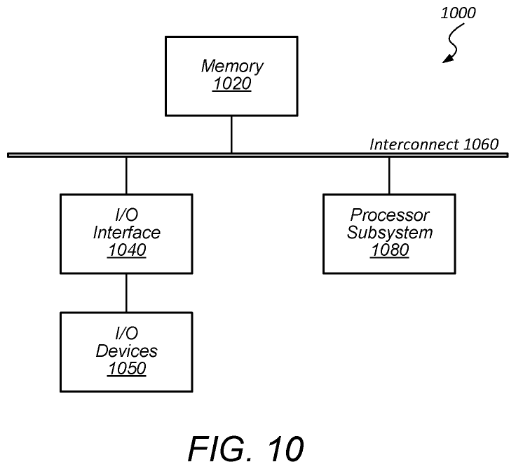

Turning now to FIG. 10, a block diagram of an exemplary computer system 1000, which may implement a node 110, database 120, and/or computer system 130 is depicted. Computer system 1000 includes a processor subsystem 1080 that is coupled to a system memory 1020 and I/O interfaces(s) 1040 via an interconnect 1060 (e.g., a system bus). I/O interface(s) 1040 is coupled to one or more I/O devices 1050. Computer system 1000 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 1000 is shown in FIG. 10 for convenience, system 1000 may also be implemented as two or more computer systems operating together.

Processor subsystem 1080 may include one or more processors or processing units. In various embodiments of computer system 1000, multiple instances of processor subsystem 1080 may be coupled to interconnect 1060. In various embodiments, processor subsystem 1080 (or each processor unit within 1080) may contain a cache or other form of on-board memory.

System memory 1020 is usable store program instructions executable by processor subsystem 1080 to cause system 1000 perform various operations described herein. System memory 1020 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 1000 is not limited to primary storage such as memory 1020. Rather, computer system 1000 may also include other forms of storage such as cache memory in processor subsystem 1080 and secondary storage on I/O Devices 1050 (e.g., a hard drive, storage array, etc.). In some embodiments, these other forms of storage may also store program instructions executable by processor subsystem 1080. In some embodiments, program instructions that when executed implement AI manager 310 and AI engine 320 may be included/stored within system memory 1020.

I/O interfaces 1040 may be any of various types of interfaces configured to couple to and communicate with other devices, according to various embodiments. In one embodiment, I/O interface 1040 is a bridge chip (e.g., Southbridge) from a front-side to one or more back-side buses. I/O interfaces 1040 may be coupled to one or more I/O devices 1050 via one or more corresponding buses or other interfaces. Examples of I/O devices 1050 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1000 is coupled to a network via a network interface device 1050 (e.g., configured to communicate over WiFi, Bluetooth, Ethernet, etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method for evaluating nodes writing to a database, comprising:
receiving, by a computer system, instance data from one or more records in the database, wherein the database is implemented as a distributed ledger and is accessible by a plurality of nodes, wherein the instance data relates to an instance of a multi-step process, and wherein the instance data includes data written by a set of the plurality of nodes that perform the instance of the multi-step process according to a particular ordering;
processing, by the computer system, the instance data to produce path data that corresponds to a path indicative of the particular ordering of the set of nodes;
receiving, by the computer system, feedback data indicative of an outcome of the instance of the multi-step process;
processing, by the computer system, the path data and the feedback data to update a model that indicates confidence scores for the plurality of nodes; and
determining, by the computer system using confidence scores indicated by the model, that one or more of the set of nodes do not satisfy a quality threshold, wherein the determining is based on the one or more nodes being associated with multiple instances of the multi-step process that have a failing outcome.

2. The method of claim 1, further comprising:
in response to determining that one or more of the set of nodes do not satisfy the quality threshold, the computer system causing a particular node in the set of nodes to perform at least one corrective action in relation to the determined one or more nodes.

3. The method of claim 2, wherein the multi-step process involves a distribution of goods from a sender to a recipient, and wherein the at least one corrective action involves inspecting goods from at least one of the one or more nodes for one or more issues.

4. The method of claim 3, wherein the feedback data is received from a particular node in the set of nodes that corresponds to the recipient.

5. The method of claim 1, wherein the distributed ledger is a blockchain that is capable of storing records, for a given instance of the multi-step process, as a branch in the blockchain, wherein the one or more records correspond to a particular branch in the blockchain.

6. The method of claim 1, wherein a portion of the one or more records that include the instance data is written by a sensor device associated with a particular node in the set of nodes.

7. The method of claim 1, wherein processing the path data and the feedback data includes the computer system performing a particular algorithm using the path data and the feedback data as input into the particular algorithm, wherein the particular algorithm is one of a machine learning algorithm or a deep learning algorithm.

8. A non-transitory, computer-readable medium having program instructions stored thereon that are capable of causing a computer system to perform operations comprising:
receiving feedback data indicative of an outcome of an instance of a multi-step process, wherein the instance was performed by a particular set of nodes;
in response to receiving the feedback data, accessing instance data stored in a plurality of records of a database that is implemented as a distributed ledger, wherein the instance data relates to the instance of the multi-step process and was written by the particular set of nodes that performed the instance;
processing the instance data to produce path data that corresponds to a path indicative of an ordering of the particular set of nodes in performing the instance; and
processing the feedback data and the path data to update a model that defines, for each node in the particular set, a confidence score that indicates an ability of that node to perform a respective one or more steps in the multi-step process, wherein the confidence score of a given node in the particular set is usable to determine whether that node satisfies a quality threshold.

9. The non-transitory, computer-readable medium of claim 8, wherein the operations further comprise:
accessing second instance data from a set of records in the database, wherein the second instance data relates to an in-progress instance of the multi-step process;
processing the second instance data to produce second path data that corresponds to a path indicative of an ordering of a second particular set of nodes;
based on the second path data and the model, determining that the in-progress instance involves one or more nodes that have a confidence score indicative of the one or more nodes not satisfying the quality threshold; and
based on the one or more nodes not satisfying the quality threshold, causing at least one corrective action to be performed in relation to the in-progress instance.

10. The non-transitory, computer-readable medium of claim 8, wherein the feedback data is indicative of a level of failure, wherein the processing of the feedback data and the path data to update the model includes:
updating the confidence score for each node in the particular set to indicate a decrease in the ability of that node to perform the multi-step process, wherein a decrease in the ability of a first node in the particular set is different than a decrease in the ability of a second node in the particular set.

11. The non-transitory, computer-readable medium of claim 10, wherein the operations further comprise:
accessing environmental data that indicates a set of environmental factors that affect a flow of the instance, wherein the environmental data is usable to facilitate a reduced decrease in the confidence score of a given node in the particular set.

12. The non-transitory, computer-readable medium of claim 8, wherein updating the model includes:
modifying the confidence score of a given node in the particular set based on whether that given node performed one or more validation tests when performing the respective one or more steps associated with that node.

13. The non-transitory, computer-readable medium of claim 8, wherein the operations further comprise:
causing a user interface to be presented to a user for receiving feedback, wherein the feedback data is received from the user via the user interface.

14. The non-transitory, computer-readable medium of claim 8, wherein the instance data is stored in an encrypted format, and wherein the operations further comprise:
decrypting, using a set of cryptographic key pairs associated with the particular set of nodes, the instance data to produce a decrypted version of the encrypted instance data.

15. A non-transitory, computer-readable medium having program instructions stored thereon that are capable of causing a computer system to perform operations comprising:
maintaining a model that indicates, for a given one of a plurality of nodes involved in a multi-step process, a confidence score indicative of an ability of that given node to perform one or more respective steps of the multi-step process;
determining that one or more records have been written to a database, wherein the one or more records correspond to an in-progress instance of the multi-step process, and wherein the one or more records are written by a set of the plurality of nodes that are performing the in-progress instance according to a particular ordering;
subsequent to accessing instance data from the one or more records, processing the instance data to produce path data that corresponds to a current path through the set of nodes performing the in-progress instance;
based on the path data and the model, producing a prediction value that is indicative of a likelihood that there is an issue associated with the in-progress instance; and
based on the prediction value satisfying a risk value, causing a corrective action to be performed in relation to the in-progress instance.

16. The non-transitory, computer-readable medium of claim 15, wherein maintaining the model includes:
receiving feedback data indicative of an outcome of a particular instance of the multi-step process, wherein the particular instance was performed by a particular set of the plurality of nodes;
in response to receiving the feedback data, accessing second instance data stored in a set of records of the database, wherein the second instance data relates to the particular instance of the multi-step process and was written by the particular set of nodes that performed the particular instance;
processing the second instance data to produce second path data that corresponds to a path indicative of an ordering of the particular set of nodes in performing the particular instance; and
based on the feedback data and the second path data, updating confidence scores indicated by the model.

17. The non-transitory, computer-readable medium of claim 16, wherein the operations further comprise:
providing an application programming interface (API) for receiving data that indicates outcomes of instances of the multi-step process, wherein the feedback data is received from a sensor device of a particular one in the set of nodes.

18. The non-transitory, computer-readable medium of claim 15, wherein producing the prediction value includes determining whether the set of nodes includes at least one node that has a confidence score that does not satisfy a quality threshold.

19. The non-transitory, computer-readable medium of claim 15, wherein the multi-step process involves movement of data values between computer systems, and wherein causing the corrective action to be performed includes analyzing the data values to determine whether the data values have been corrupted.

20. The non-transitory, computer-readable medium of claim 15, wherein the one or more records are part of a blockchain, and wherein the operations further comprise maintaining an instance of the blockchain at the database.
